(19) United States
(12) Patent Application Publication
(10) Pub. No.: US 2013/0208238 A1
(43) Pub. Date: Aug. 15, 2013

(54) METHOD AND APPARATUS FOR SUPPLYING AN ELECTRO-ACTIVE MATERIAL TO AN ELECTRO-ACTIVE OPTICAL SYSTEM

(71) Applicant: PixelOptics, Inc., (US)

(72) Inventors: Ronald D. Blum, Roanoke, VA (US); William Kokonaski, Gig Harbor, WA (US); Anthony Van Heugten, Sarasota, FL (US); David Boyd, Roanoke, VA (US); Venki Iyer, Roanoke, VA (US)

(73) Assignee: PIXELOPTICS, INC., Roanoke, VA (US)

(21) Appl. No.: 13/757,372

(22) Filed: Feb. 1, 2013

Related U.S. Application Data
(60) Provisional application No. 61/593,925, filed on Feb. 2, 2012.
(60) Provisional application No. 61/598,093, filed on Feb. 13, 2012.
(60) Provisional application No. 61/599,195, filed on Feb. 15, 2012.
(60) Provisional application No. 61/601,776, filed on Feb. 22, 2012.
(60) Provisional application No. 61/603,415, filed on Feb. 27, 2012.
(60) Provisional application No. 61/618,354, filed on Mar. 30, 2012.
(60) Provisional application No. 61/666,402, filed on Jun. 29, 2012.

(51) Int. Cl. B29D 11/00; G02C 7/02

(52) U.S. Cl. CPC B29D 11/00; G02C 7/022
USPC 351/159.39; 264/400; 29/428

(57) ABSTRACT

The present invention relates generally to methods of fabricating an electro-active optical structure, such as an electro-active lens or an electro-active lens blank. In some embodiments, the invention relates to fabrication methods that comprise an improved process for delivering an electro-active material into a cavity, resulting in electro-active structures that can be manufactured in less time and with lowered costs.

### CROSS-REFERENCE TO RELATED APPLICATIONS

The present application claims the benefit of priority to U.S. Provisional Patent Application No. 61/593,925, filed Feb. 2, 2012, U.S. Provisional Patent Application No. 61/598,093, filed Feb. 13, 2012, U.S. Provisional Patent Application No. 61/599,195, filed Feb. 15, 2012, U.S. Provisional Patent Application No. 61/601,776, filed Feb. 22, 2012, U.S. Provisional Patent Application No. 61/603,415, filed Feb. 27, 2012, U.S. Provisional Patent Application No. 61/618,354, filed Mar. 30, 2012, and U.S. Provisional Patent Application No. 61/666,402, filed Jun. 29, 2012. Each of the aforementioned applications is hereby incorporated by reference as though fully set forth herein.

### FIELD OF THE INVENTION

The present invention relates generally to methods of fabricating an electro-active optical structure, such as an electro-active lens or an electro-active lens blank. In some embodiments, the invention relates to fabrication methods that comprise an improved process for delivering an electro-active material into a cavity, resulting in electro-active structures that can be manufactured in less time and with lowered costs.

### BACKGROUND

Fabricating electro-active optical systems, such as lenses or lens blanks, is a complex process. Such systems can have surface relief diffractive zones that are adjacent to a cavity that is filed with an electro-active material, e.g., a material comprising liquid crystals. Various systems and manufacturing methods are described in U.S. Pat. Nos. 5,712,721; 6,986,579; 7,019,890; 7,290,875; 7,393,101; 7,604,439; 7,654,667; 7,728,949; and 7,883,207, and in U.S. Patent Application Publication No. 2009/0256977. For example, one can fabricate an electro-active optical system by providing two substrates, where a surface of one of substrates comprises one or more relief structures (e.g., refractive or diffractive relief structures). The electro-active material is deposited onto the relief structures, e.g., by ink jet printing, and the two substrates are joined, thereby forming an electro-active optical system comprising a refractive or diffractive cavity filled with an electro-active material.

Such processes can require great precision. In some instances, the peaks of the relief structures can come close to touching the other substrate, once the two substrates are joined. Therefore, it can be important to distribute the proper volume of electro-active material to the substrate. If too little is used, undesirable voids will occur in the cavity. If too much is used, sealing the cavity can be difficult. And even if the cavity is filled properly, physical changes to the optical system during surfacing, polishing, etc., may alter the cavity enough to affect its volume, and thereby affect whether the cavity is underfilled or overfilled with electro-active material.

Therefore, it may be desirable to develop a process that permits the electro-active cavity to be filled with electro-active material after the cavity is formed, and, in some instances, near the end of the finishing process.

### SUMMARY OF THE INVENTION

In at least one aspect, the invention provides methods of fabricating an electro-active optical structure, comprising: (a) providing a first optical substrate having a first surface, wherein the first surface is a curved surface; (b) providing a second optical substrate having a first surface and an opposing second surface, wherein the first surface is a curved surface and the second surface is a curved surface comprising one or more relief structures; (c) securing the second optical substrate to the first optical substrate such that the first surface of the first substrate faces the second surface of the second substrate, thereby forming a cavity between the one or more relief structures and the first surface of the first substrate; (d) forming an aperture that runs between the cavity and an outer surface of either the first substrate or the second substrate; (e) via the aperture, introducing an electro-active material into the cavity; and (f) sealing the aperture to prevent loss of electro-active material from the cavity.

In another aspect, the invention provides methods of fabricating an electro-active optical structure, comprising: (a) providing: a first optical substrate having a first surface, wherein the first surface is a curved surface; a second optical substrate having a first surface and an opposing second surface, wherein the first surface is a curved surface and the second surface is a curved surface comprising one or more relief structures; wherein the second optical substrate is disposed on the first optical substrate such that the first surface of the first substrate faces the second surface of the second substrate, thereby forming a cavity between the one or more relief structures and the first surface of the first substrate; (b) forming an aperture that runs between the cavity and an outer surface of either the first substrate or the second substrate; (c) via the aperture, introducing an electro-active material into the cavity; and (d) sealing the aperture to prevent loss of electro-active material from the cavity.

In another aspect, the invention provides methods of fabricating an electro-active optical structure, comprising: (a) providing: a first optical substrate having a first surface, wherein the first surface is a curved surface; a second optical substrate having a first surface and an opposing second surface, wherein the first surface is a curved surface and the second surface is a curved surface comprising one or more relief structures; wherein the second optical substrate is disposed on the first optical substrate such that the first surface of the first substrate faces the second surface of the second substrate, thereby forming a cavity between the one or more relief structures and the first surface of the first substrate; and wherein an aperture is formed that runs between the cavity and an outer surface of either the first substrate or the second substrate; (b) via the aperture, introducing an electro-active material into the cavity; and (c) sealing the aperture to prevent loss of electro-active material from the cavity.

In another aspect, the invention provides electro-active optical structures comprising: (a) a first optical substrate having a first surface, wherein the first surface is a curved surface; and (b) a second optical substrate having a first surface and an opposing second surface, wherein the first surface is a curved surface and the second surface is a curved surface comprising one or more relief structures; wherein the second optical substrate is disposed on the first optical substrate such that the first surface of the first substrate faces the second surface of the second substrate, thereby forming a cavity between the one or more relief structures and the first surface of the first substrate, the cavity being substantially filled with an electro-active material; and wherein a sealed aperture runs between the cavity and the first surface of the second substrate.

In another aspect, the invention provides methods for laser drilling, comprising: (a) providing a transparent structure having an internal cavity, the internal cavity a first surface and an opposing second surface; (b) using a laser, drilling an aperture from an outer surface of the transparent structure to the first surface of the internal cavity; (c) detecting ablation of the second surface of the internal cavity; and (d) upon detecting ablation of the second surface of the internal cavity, reducing the power of the laser.

Further aspects and embodiments of the invention are provided in the detailed description that follows and in the accompanying figures.

### BRIEF DESCRIPTION OF DRAWINGS

The application includes the following figures. These figures depicts certain illustrative embodiments of various aspects of the invention. In some instances, the figures do not necessarily provide a proportional illustration of an actual embodiment of the invention, but may emphasize certain features for purposes of illustration. The figures are not intended to limit the scope of the claimed subject matter apart from an express indication to the contrary.

FIG. 1 depicts a flow diagram illustrating a method of making an electro-active optical system according to at least one embodiment of the invention.

FIG. 2 depicts a top view of an optical substrate having an aperture formed according to at least one embodiment of the invention.

FIG. 3 depicts an electro-active optical system made according to at least one embodiment of the invention fitted into a pair of spectacle frames.

FIG. 4 depicts the filling of a cavity in an electro-active optical system formed according to at least one embodiment of the invention.

FIG. 5 depicts an electro-active optical system according to at least one embodiment of the invention.

FIG. 6 depicts a flow diagram illustrating a method of laser drilling according to at least one embodiment of the invention.

FIG. 7 depicts a drilling step according to at least one embodiment of the invention, where the laser drilling has not yet reached its end.

FIG. 8 depicts a drilling step according to at least one embodiment of the invention, where the laser drilling has reached its end.

### DETAILED DESCRIPTION

The following description recites various aspects and embodiments of the present invention. No particular embodiment is intended to define the scope of the invention. Rather, the embodiments merely provide non-limiting examples various compositions, apparatuses, and methods that are at least included within the scope of the invention. The description is to be read from the perspective of one of ordinary skill in the art; therefore, information well known to the skilled artisan is not necessarily included.

As used herein, the articles “a,” “an,” and “the” include plural referents, unless expressly and unequivocally disclaimed.

As used herein, the conjunction “or” does not imply a disjunctive set. Thus, the phrase “A or B is present” includes each of the following scenarios: (a) A is present and B is not present; (b) A is not present and B is present; and (c) A and B are both present. Thus, the term “or” does not imply an either/or situation, unless expressly indicated.

As used herein, the term “comprise,” “comprises,” or “comprising” implies an open set, such that other elements can be present in addition to those expressly recited.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

In at least one aspect, the invention provides methods of fabricating an electro-active optical structure, comprising: (a) providing a first optical substrate having a first surface, wherein the first surface is a curved surface; (b) providing a second optical substrate having a first surface and an opposing second surface, wherein the first surface is a curved surface and the second surface is a curved surface comprising one or more relief structures; (c) securing the second optical substrate to the first optical substrate such that the first surface of the first substrate faces the second surface of the second substrate, thereby forming a cavity between the one or more relief structures and the first surface of the first substrate; (d) forming an aperture that runs between the cavity and an outer surface of either the first substrate or the second substrate; (e) via the aperture, introducing an electro-active material into the cavity; and (f) sealing the aperture to prevent loss of electro-active material from the cavity.

As used herein, the term “optical substrate” refers to any substrate suitable for use as a lens or lens blank, or suitable for being formed into a lens or lens blank. In general, the optical substrate is a transparent material, meaning that it transmits at least 75%, or at least 80%, or at least 85%, or at least 90%, or at least 95%, or at least 97%, or at least 99% of visible light. The invention is not limited to any particular material, so long as the material is suitable for use as an optical substrate. Suitable materials include, but are not limited to, glass, quartz, or a polymeric material, such as polycarbonate. The material can have any index of refraction suitable for use in optical applications.

The method includes providing a first optical substrate having a curved first surface. The first surface of the first optical substrate can have any suitable radius of curvature, depending on the desired curvature of the resulting structure. In some embodiments, the first surface of the first optical substrate is a convex curved surface. In some other embodiments, the curved first surface of the first optical substrate is a concave surface.

The other surfaces of the first optical substrate can have any suitable relationship with the first surface. In some embodiments, the electro-active optical structure is a lens blank. In some such embodiments, the other surfaces are positioned relative to the first surface in the same manner as the unfinished surfaces of a lens blank. In some such embodiments, the thickness of the first optical substrate ranges from 25 mm to 5 cm, or from 50 mm to 3 cm, or from 1 to 1.5 cm. The thickness need not be uniform across the substrate, e.g., in embodiments where the surface opposite the first surface is a flat surface. In some other embodiments, the thickness of the first optical substrate ranges from 1 to 20 mm, or from 3 to 10 mm, or from 4 to 9 mm, or from 5 to 8 mm.

The method also includes providing a second optical substrate having a first surface and an opposing second surface. In some embodiments, the first and second surfaces of the second optical substrate are curved surfaces. In some such embodiments, the first surface of the second optical substrate is a convex surface, while in other embodiments, the first surface of the second optical substrate is a concave surface. In some embodiments, the second surface of the second optical substrate is a concave surface while in other embodiments, the second surface of the second optical substrate is a convex surface. In such embodiments, the first and second surfaces of the second optical substrate can have any suitable radius of curvature. In some embodiments, the first and second surfaces of the second substrate have similar radii of curvature, for example the radius of curvature of the first surface of the second substrate is within 1%, or 2%, or 3%, or 5%, or 7%, or 10%, or 15%, or 20% of the radius of curvature of the second surface of the second substrate. In some embodiments, the first of the first substrate and the second surface of the second substrate have similar radii of curvature, for example the radius of curvature of the first surface of the first substrate is within 1%, or 2%, or 3%, or 5%, or 7%, or 10%, or 15%, or 20% of the radius of curvature of the second surface of the second substrate.

The second optical substrate can have any suitable thickness. In some embodiments, the second optical substrate has a thickness that ranges from 0.5 to 2 mm, or from 0.7 to 1.8 mm. The thickness need not be uniform across the substrate.

In some embodiments, the second surface of the second optical substrate comprises one or more relief structures. In some embodiments, the first surface of the second substrate comprises a plurality of relief structures, for example from 2 to 500, or from 5 to 200, or from 10 to 100 relief structures. The relief structures can be formed in any suitable way, e.g., by any suitable combination of recesses and extensions from the plane of the surface. In some embodiments, the relief structures are diffractive structures. In some embodiments, the relief structures are refractive structures. In some other embodiments, the relief structures are Fresnel structures. The relief structures can be of any suitable size and shape. In some embodiments, the relief structures have a height ranging from 1 nm to 3 mm, or from 1 nm to 2 mm, or from 1 nm to 1 mm, or from 1 nm to 500 μm, or from 10 nm to 500 μm, or from 100 nm to 500 μm, or from 1 μm to 500 μm, or from 1 μm to 20 μm, or from 1 μm to 10 μm, or from 1 μm to 50 μm. In embodiments where the surface comprises a plurality of relief structures, the relief structures can be separated by any suitable distance. In some embodiments, one or more pairs of adjacent relief structures are separated by a distance ranging from 1 nm to 3 mm, or from 1 nm to 2 mm, or from 1 nm to 1 mm, or from 1 nm to 500 μm, or from 10 nm to 500 μm, or from 100 nm to 500 μm, or from 1 μm to 500 μm, or from 1 μm to 50 μm, or from 1 μm to 20 μm, or from 1 μm to 10 μm. In some embodiments, the relief structures are diffractive structures. In some other embodiments, the relief structures are refractive structures. In some other embodiments, the relief structures are Fresnel structures.

The second surface of the second optical substrate can also include a recessed channel, for example, that runs through or adjacent to one or more of the one or more relief structures. Such a channel can, in some embodiments, permit the electro-active material to flow more readily across the channel upon filling of the cavity with an electro-active material.

The method also includes securing the second optical substrate to the first optical substrate. In this context, the term “securing” does not imply any particular way of joining the two substrates. Any suitable means of securing the two substrates together can be used. In some embodiments, the securing comprises using an adhesive. In such embodiments, the an adhesive can be applied to the first optical substrate or the second optical substrate, or both. The adhesive can be applied by any suitable means, including, but not limited to, using an adhesive tape, using an applicator (e.g. brush), and spraying. In some embodiments, the adhesive is applied across the entire interface between the first optical substrate and the second optical substrate. In other embodiments, the adhesive is applied across at least a portion of the interface between the first optical substrate and the second optical substrate. In some embodiments, the adhesive is applied in a ring around the exterior edge of the interface between the first optical substrate and the second optical substrate. Any suitable adhesive can be used. In some embodiments, the adhesive is a curable adhesive, including, but not limited to, a thermally curable adhesive or a photo-curable adhesive (e.g., a UV-curable adhesive).

The first optical substrate and the second optical substrate are adhered together such that the first surface of the first optical substrate faces the second surface of the second optical substrate. In embodiments where the second optical substrate comprises one or more relief structures, a cavity is formed between the relief structures on the second surface of the second optical substrate and the first surface of the first optical substrate. In embodiments where the relief structures are diffractive structures, the cavity is a diffractive cavity. In embodiments where the relief structures are refractive structures, the cavity is a refractive cavity. In some embodiments, the resulting cavity is a sealed cavity. A sealed cavity can be formed, for example, when an adhesive is applied in a ring around the exterior edge of the interface between the first optical substrate and the second optical substrate. The cavity can have any suitable dimensions. In some embodiments, the height of the cavity is greater than the height of the relief structures, for example, at least two times, or at least three times, or at least four times, or at least 5 times the height of the relief structures.

In some embodiments, the securing of the two optical substrates comprises forming a semi-finished lens blank. As used herein, a “semi-finished lens blank” refers to structure having a finished outer surface (i.e., an outer surface suitable for use as one surface of a lens) and an opposing unfinished outer surface (i.e., an outer surface that is not (or not yet) suitable for use as one surface of a lens. In some such embodiments, the method can further include a finishing step, wherein material from the unfinished outer surface is ablated (e.g., ground away) to form a finished lens. In some further embodiments, such as where the lens is a lens for use as a spectacle lens, the method can further include an edging step, wherein the finished lens is formed into the shape suitable for a particular eyeglass frame.

The method includes forming an aperture (e.g., a tunnel or hole) that runs between the cavity and the outer surface of either the first optical substrate or the second optical substrate. In some embodiments, the aperture runs from the second surface of the second optical substrate to the first surface of the second optical substrate. In some other embodiments, the aperture runs from the first surface of the first optical substrate to an outer surface of the first optical substrate, e.g., a surface that lies opposite the first surface. The aperture can have any suitable diameter. In some embodiments, the diameter ranges from 1 nm to 500 μm, or from 10 nm to 400 μm, or from 100 nm to 250 μm, or from 1 to 200 μm. The diameter need not be uniform throughout its distance. In some embodiments, for example, the diameter can taper, for example by becoming narrower in the region closer to the cavity. In some such embodiments, the taper is up to 25%, or up to 20%, or up to 15%, or up to 10%, or up to 5%. Other variations in the diameter of the aperture are within the scope of the invention.

Any suitable number of apertures can be formed. In some embodiments, the method comprises forming a single aperture. In some other embodiments, the method includes forming multiple apertures, such as two apertures, or three apertures, or four apertures, or five apertures.

The aperture can be formed by any suitable means. In some embodiments, the aperture is formed by mechanical drilling using, for example, a drill bit. In other embodiments, the aperture is formed through the use of a chemical agent, e.g., a chemical etchant. In some other embodiments, the aperture is formed by a laser. Any suitable laser can be used. In some embodiments, an excimer laser is used. In some embodiments, the aperture is formed by the laser drilling method described below, and which is one aspect of the invention.

The method includes introducing an electro-active material to the cavity (e.g., sealed cavity) via the aperture. In some embodiments, the cavity is filled with an electro-active material. Electro-active materials are well known in the art, and include, but are not limited to, optical birefringent materials, such as liquid crystals. In some embodiments, the electro-active material only partially fills the cavity. In some other embodiments, the electro-active material fills the cavity, i.e., occupies at least 75%, or at least 80%, or at least 85%, or at least 90%, or at least 95% of the volume of the cavity, or at least 97% of the volume of the cavity, or at least 99% of the volume of the cavity. In some embodiments, the cavity is overfilled, meaning that some amount of the electro-active material resides in the portion of the aperture immediately adjacent to the cavity. In some embodiments, the cavity is overfilled by no more than 5%, or no more than 3%, or no more than 2%, or no more than 1%, or no more than 0.5%. The introducing of the electro-active material to the cavity can occur under any suitable conditions. In some embodiments, the introducing occurs under vacuum conditions. In some other embodiments, the introducing does not occur under vacuum conditions, such as atmospheric pressure conditions.

The method includes sealing the aperture, for example, to prevent loss of the electro-active material from the cavity. In some embodiments, the sealing comprises filling substantially all of the free volume remaining in the aperture following introduction of the electro-active material with a sealant, e.g., filling at least 95%, or at least 97%, or at least 99% of the free volume of the aperture. In some other embodiments, however, a lesser volume is filled with sealant, for example 5% to 95%, or 10% to 90%, or 20% to 80%. In some such embodiments, the unfilled portion of the aperture lies toward the outer end of the aperture and away from the end that lies closer to the cavity. Any suitable sealing material can be used for the sealant. In some embodiments, the sealant is a curable material, such as a thermally curable material or a photo-curable material (e.g., a UV-curable material). The sealant can have any suitable index of refraction. In some embodiments, the sealant has an index of refraction that is no more than 0.7, or no more than 0.6, or no more than 0.5, or no more than 0.4, or no more than 0.3 units different from the index of refraction of the material through which the aperture is formed. In some embodiments, the sealing material is transparent, meaning that it transmits at least 75%, or at least 80%, or at least 85%, or at least 90%, or at least 95%, or at least 97%, or at least 99% of visible light.

In embodiments where the method includes forming multiple apertures, the sealing includes filling each of the multiple apertures, according to the embodiments described above.

In some embodiments, the method can include disposing various electrical structures, such as electrical contacts and/or electrical wires on one or both of the optical substrates. In some embodiments, these electrical structures are transparent electrical structures, meaning that they transmit at least 75%, or at least 80%, or at least 85%, or at least 90%, or at least 95%, or at least 97%, or at least 99% of visible light. These electrical structures can be made of any suitable transparent conductive material, such as indium tin oxide (ITO), conductive polymers, carbon nanotubes, or any mixtures thereof. Such structures can be disposed on the surfaces of the curved substrate and/or the thin film. These structures can be disposed on the surfaces by any suitable method, including but not limited to, various lithographic or printing methods.

In some embodiments, the electro-active optical structure is a lens blank. In some such embodiments, the lens blank is designed so as to be finished into the prescription for a particular wearer or into a range of prescriptions for a range of wearers. In some other embodiments, the electro-active optical structure is a lens. In some such embodiments, the lens is designed so as to be finished into the prescription for a particular wearer or into a range of prescriptions for a range of wearers.

An any of the embodiments of the invention, the method can include disposing various coatings on any suitable surfaces of the first or second optical substrates. Such coatings include, but are not limited to, hard coatings, scratch-resistant coatings, antireflective coatings, and the like.

In some embodiments, the method can also include creating edging on the electro-active optical system (e.g., on the edges of the first or second optical substrates, or both) to permit the resulting lens to be fitted into a set of spectacle frames. In some embodiments, the method includes fitting the lens of the invention into a set of spectacle frames.

In some embodiments, where the method is a method of making an electro-active optical lens, the forming step comprises forming a lens blank, such as an semi-finished lens blank. In some such embodiments, the method further comprises a step of processing the semi-finished lens blank into a lens (including a finished lens or a partially finished lens). This processing can be included at any suitable stage of the making process. For example, in some embodiments, the processing step is carried out after the securing step, such as before the forming step of the aperture, or before introducing the electro-active material to the cavity, or before the sealing of the aperture. In some other embodiments, the processing step is carried out after the sealing of the aperture.

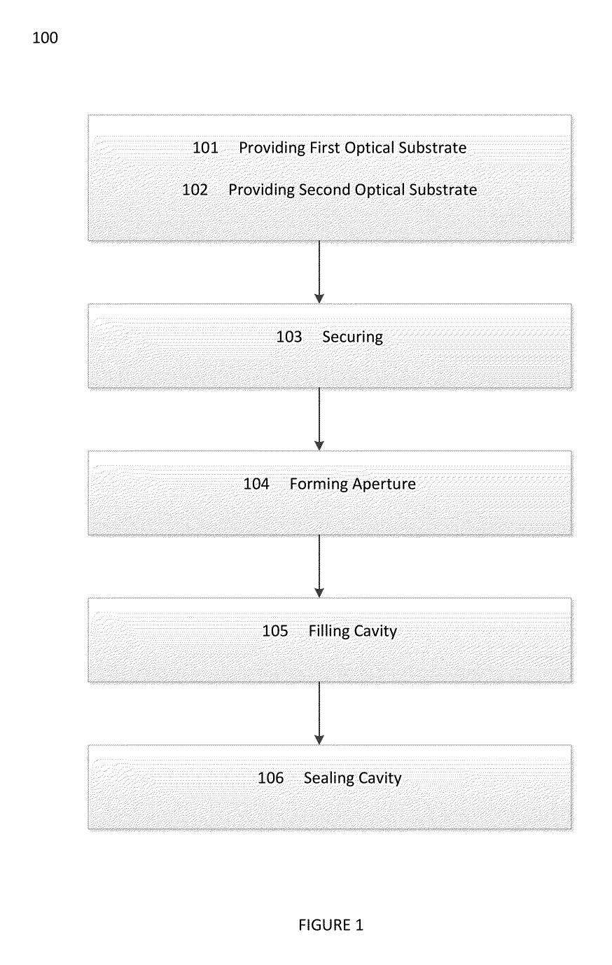

FIG. 1 depicts a flow diagram illustrating a method of making an electro-active optical system according to at least one embodiment of the invention 100. The flow diagram shows steps of: providing a first optical substrate having a first surface, wherein the first surface is a curved convex surface 101; providing a second optical substrate having a first surface and an opposing second surface, wherein the first surface is a curved convex surface and the second surface is a curved concave surface comprising one or more relief structures 102; securing the second optical substrate to the first optical substrate such that the first surface of the first substrate faces the second surface of the second substrate, thereby forming a cavity between the one or more relief structures and the first surface of the first substrate 103; forming an aperture that runs between the cavity and an outer surface of either the first substrate or the second substrate 104; via the aperture, introducing an electro-active material into the cavity 105; and sealing the aperture to prevent loss of electro-active material from the cavity 106.

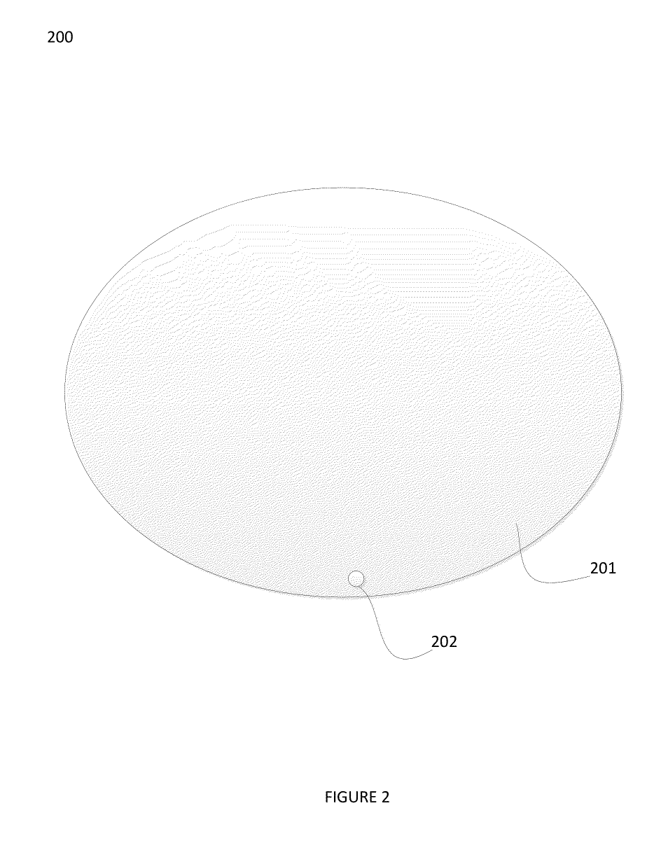

FIG. 2 depicts a top view of an optical substrate having an aperture formed according to at least one embodiment of the invention 200. The figure shows an optical substrate 201 from the top, where the surface into which the drilling is initiated faces the viewer. The figure also shows an aperture 202.

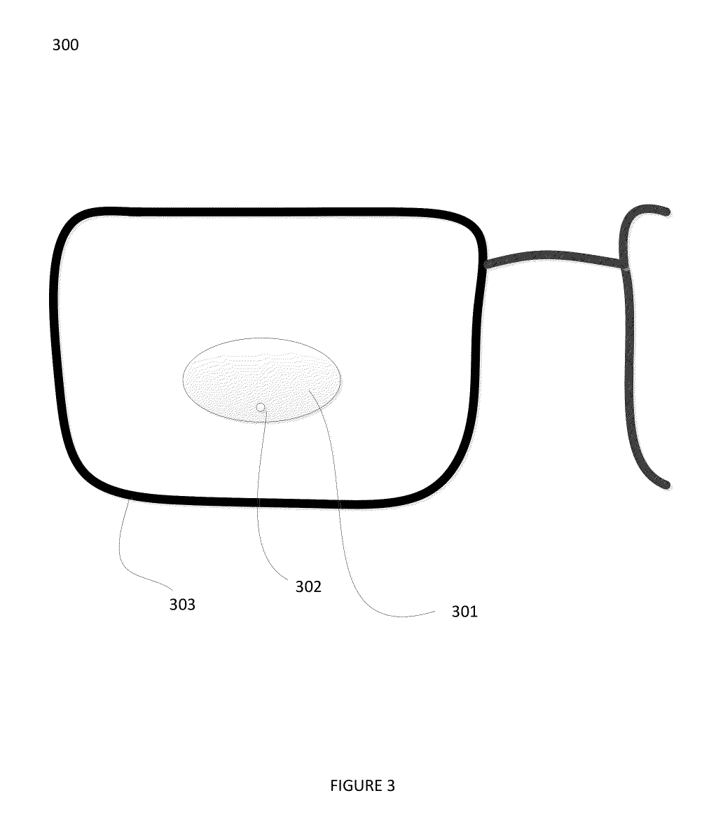

FIG. 3 depicts an electro-active optical system made according to at least one embodiment of the invention fitted into a pair of spectacle frames 300. The figure shows a first optical substrate 301, a second optical substrate 302, an aperture 303, and spectacle frames 304.

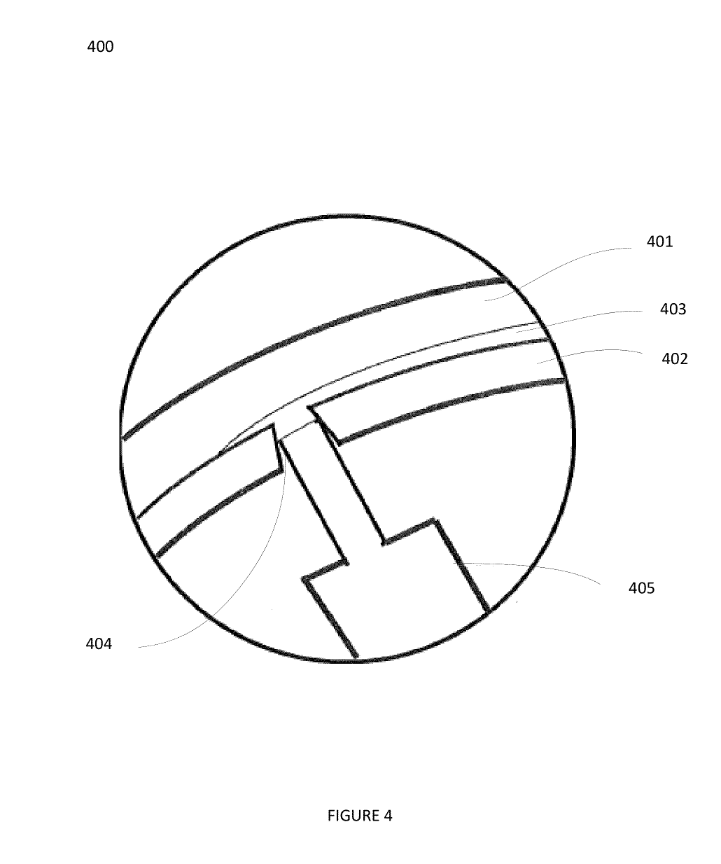

FIG. 4 depicts the filling of a cavity in an electro-active optical system formed according to at least one embodiment of the invention 400. The figure depicts the first optical substrate 401, the second optical substrate 402, the cavity 403, the aperture 404, and an apparatus for delivering the electro-active material 405.

In another aspect, the invention provides methods of fabricating an electro-active optical structure, comprising: (a) providing: a first optical substrate having a first surface, wherein the first surface is a curved surface; a second optical substrate having a first surface and an opposing second surface, wherein the first surface is a curved surface and the second surface is a curved surface comprising one or more relief structures; wherein the second optical substrate is disposed on the first optical substrate such that the first surface of the first substrate faces the second surface of the second substrate, thereby forming a cavity between the one or more relief structures and the first surface of the first substrate; (b) forming an aperture that runs between the cavity and an outer surface of either the first substrate or the second substrate; (c) via the aperture, introducing an electro-active material into the cavity; and (d) sealing the aperture to prevent loss of electro-active material from the cavity. Any of the embodiments described above for methods of fabricating an electro-active optical structure can be suitable incorporated into the methods of this aspect of the invention, and are incorporated into this paragraph of the disclosure as though fully set forth herein.

In another aspect, the invention provides methods of fabricating an electro-active optical structure, comprising: (a) providing: a first optical substrate having a first surface, wherein the first surface is a curved surface; a second optical substrate having a first surface and an opposing second surface, wherein the first surface is a curved surface and the second surface is a curved surface comprising one or more relief structures; wherein the second optical substrate is disposed on the first optical substrate such that the first surface of the first substrate faces the second surface of the second substrate, thereby forming a cavity between the one or more relief structures and the first surface of the first substrate; and wherein an aperture is formed that runs between the cavity and an outer surface of either the first substrate or the second substrate; (b) via the aperture, introducing an electro-active material into the cavity; and (c) sealing the aperture to prevent loss of electro-active material from the cavity. Any of the embodiments described above for methods of fabricating an electro-active optical structure can be suitable incorporated into the methods of this aspect of the invention, and are incorporated into this paragraph of the disclosure as though fully set forth herein.

In another aspect, the invention provides electro-active optical structures comprising: (a) a first optical substrate having a first surface, wherein the first surface is a curved surface; and (b) a second optical substrate having a first surface and an opposing second surface, wherein the first surface is a curved surface and the second surface is a curved surface comprising one or more relief structures; wherein the second optical substrate is disposed on the first optical substrate such that the first surface of the first substrate faces the second surface of the second substrate, thereby forming a cavity between the one or more relief structures and the first surface of the first substrate, the cavity being substantially filled with an electro-active material; and wherein a sealed aperture runs between the cavity and the first surface of the second substrate.

As used herein, the term “optical substrate” refers to any substrate suitable for use as a lens or lens blank, or suitable for being formed into a lens or lens blank. In general, the optical substrate is a transparent material, meaning that it transmits at least 75%, or at least 80%, or at least 85%, or at least 90%, or at least 95%, or at least 97%, or at least 99% of visible light. The invention is not limited to any particular material, so long as the material is suitable for use as an optical substrate. Suitable materials include, but are not limited to, glass, quartz, or a polymeric material, such as polycarbonate. The material can have any index of refraction suitable for use in optical applications.

The electro-active structure comprises a first optical substrate having a curved surface. The first surface of the first optical substrate can have any suitable radius of curvature, depending on the desired curvature of the resulting structure. In some embodiments, the first surface of the first optical substrate is a convex curved surface. In some other embodiments, the curved first surface of the first optical substrate is a concave surface.

The other surfaces of the first optical substrate can have any suitable relationship with the first surface. In some embodiments, the electro-active optical structure is a lens blank. In some such embodiments, the other surfaces are positioned relative to the first surface in the same manner as the unfinished surfaces of a lens blank. In some such embodiments, the thickness of the first optical substrate ranges from 25 mm to 5 cm, or from 50 mm to 3 cm, or from 1 to 1.5 cm. The thickness need not be uniform across the substrate, e.g., in embodiments where the surface opposite the first surface is a flat surface. In some other embodiments, the thickness of the first optical substrate ranges from 1 to 20 mm, or from 3 to 10 mm, or from 4 to 9 mm, or from 5 to 8 mm.

The electro-active structure also comprises a second optical substrate having a first surface and an opposing second surface. In some embodiments, the first and second surfaces of the second optical substrate are curved surfaces. In some such embodiments, the first surface of the second optical substrate is a convex surface, while in other embodiments, the first surface of the second optical substrate is a concave surface. In some embodiments, the second surface of the second optical substrate is a concave surface, while in other embodiments, the second surface of the second optical substrate is a convex surface. In such embodiments, the first and second surfaces of the second optical substrate can have any suitable radius of curvature. In some embodiments, the first and second surfaces of the second substrate have similar radii of curvature, for example the radius of curvature of the first surface of the second substrate is within 1%, or 2%, or 3%, or 5%, or 7%, or 10%, or 15%, or 20% of the radius of curvature of the second surface of the second substrate. In some embodiments, the first of the first substrate and the second surface of the second substrate have similar radii of curvature, for example the radius of curvature of the first surface of the first substrate is within 1%, or 2%, or 3%, or 5%, or 7%, or 10%, or 15%, or 20% of the radius of curvature of the second surface of the second substrate.

The second optical substrate can have any suitable thickness. In some embodiments, the second optical substrate has a thickness that ranges from 0.5 to 2 mm, or from 0.7 to 1.8 mm. The thickness need not be uniform across the substrate.

In some embodiments, the second surface of the second optical substrate comprises one or more relief structures. In some embodiments, the first surface of the second substrate comprises a plurality of relief structures, for example from 2 to 500, or from 5 to 200, or from 10 to 100 relief structures. The relief structures can be formed in any suitable way, e.g., by any suitable combination of recesses and extensions from the plane of the surface. In some embodiments, the relief structures are diffractive structures. In some embodiments, the relief structures are refractive structures. In some other embodiments, the relief structures are Fresnel structures. The relief structures can be of any suitable size and shape. In some embodiments, the relief structures have a height ranging from 1 nm to 3 mm, or from 1 nm to 2 mm, or from 1 nm to 1 mm, or from 1 nm to 500 μm, or from 10 nm to 500 μm, or from 100 nm to 500 μm, or from 1 μm to 500 μm, or from 1 μm to 20 μm, or from 1 μm to 10 μm, or from 1 μm to 50 μm. In embodiments where the surface comprises a plurality of relief structures, the relief structures can be separated by any suitable distance. In some embodiments, one or more pairs of adjacent relief structures are separated by a distance ranging from 1 nm to 3 mm, or from 1 nm to 2 mm, or from 1 nm to 1 mm, or from 1 nm to 500 μm, or from 10 nm to 500 μm, or from 100 nm to 500 μm, or from 1 μm to 500 μm, or from 1 μm to 50 μm, or from 1 μm to 20 μm, or from 1 μm to 10 μm. In some embodiments, the relief structures are diffractive structures. In some other embodiments, the relief structures are refractive structures. In some other embodiments, the relief structures are Fresnel structures.

The second surface of the second optical substrate can also include a recessed channel, for example, that runs through or adjacent to one or more of the one or more relief structures. Such a channel can, in some embodiments, permit the electro-active material to flow more readily across the channel upon filling of the cavity with an electro-active material.

In some embodiments, the second optical substrate is secured to the first optical substrate. In this context, the term “secured” does not imply any particular way in which the two substrates are joined. Any suitable means of securing the two substrates together can be used. In some embodiments, the optical substrates are secured together using an adhesive. In such embodiments, the an adhesive can be applied to the first optical substrate or the second optical substrate, or both. The adhesive can be applied by any suitable means, including, but not limited to, using an adhesive tape, using an applicator (e.g. brush), and spraying. In some embodiments, the adhesive is applied across the entire interface between the first optical substrate and the second optical substrate. In other embodiments, the adhesive is applied across at least a portion of the interface between the first optical substrate and the second optical substrate. In some embodiments, the adhesive is applied in a ring around the exterior edge of the interface between the first optical substrate and the second optical substrate. Any suitable adhesive can be used. In some embodiments, the adhesive is a curable adhesive, including, but not limited to, a thermally curable adhesive or a photo-curable adhesive (e.g., a UV-curable adhesive).

The first optical substrate and the second optical substrate are adhered together such that the first surface of the first optical substrate faces the second surface of the second optical substrate. In embodiments where the second optical substrate comprises one or more relief structures, a cavity is formed between the relief structures on the second surface of the second optical substrate and the first surface of the first optical substrate. In embodiments where the relief structures are diffractive structures, the cavity is a diffractive cavity. In embodiments where the relief structures are refractive structures, the cavity is a refractive cavity. In some embodiments, the resulting cavity is a sealed cavity. A sealed cavity can be formed, for example, when an adhesive is applied in a ring around the exterior edge of the interface between the first optical substrate and the second optical substrate. The cavity can have any suitable dimensions. In some embodiments, the height of the cavity is greater than the height of the relief structures, for example, at least two times, or at least three times, or at least four times, or at least 5 times the height of the relief structures.

The electro-active optical system comprises an aperture (e.g., a tunnel or hole) that runs between the cavity and the outer surface of either the first optical substrate or the second optical substrate. In some embodiments, the aperture is at least partially filled with a sealant. In some embodiments, the aperture runs from the second surface of the second optical substrate to the first surface of the second optical substrate. In some other embodiments, the aperture runs from the first surface of the first optical substrate to an outer surface of the first optical substrate, e.g., a surface that lies opposite the first surface. The aperture can have any suitable diameter. In some embodiments, the diameter ranges from 1 nm to 500 μm, or from 10 nm to 400 μm, or from 100 nm to 250 μm, or from 1 to 200 μm. The diameter need not be uniform throughout its distance. In some embodiments, for example, the diameter can taper, for example by becoming narrower in the region closer to the cavity. In some such embodiments, the taper is up to 25%, or up to 20%, or up to 15%, or up to 10%, or up to 5%. Other variations in the diameter of the aperture are within the scope of the invention.

Any suitable number of apertures can be present. In some embodiments, only a single aperture is present. In some other embodiments, multiple apertures are present, such as two apertures, or three apertures, or four apertures, or five apertures.

In some embodiments, the cavity is at least partly filled with an electro-active material. In some such embodiments, the electro-active material is prevented from escaping the cavity by means of the sealed aperture. Electro-active materials are well known in the art, and include, but are not limited to, optical birefringent materials, such as liquid crystals. In some embodiments, the electro-active material only partially fills the cavity. In some other embodiments, the electro-active material fills the cavity, i.e., occupies at least 75%, or at least 80%, or at least 85%, or at least 90%, or at least 95% of the volume of the cavity, or at least 97% of the volume of the cavity, or at least 99% of the volume of the cavity. In some embodiments, the cavity is overfilled, meaning that some amount of the electro-active material resides in the portion of the aperture immediately adjacent to the cavity. In some embodiments, the cavity is overfilled by no more than 5%, or no more than 3%, or no more than 2%, or no more than 1%, or no more than 0.5%. The introducing of the electro-active material to the cavity can occur under any suitable conditions. In some embodiments, the introducing occurs under vacuum conditions. In some other embodiments, the introducing does not occur under vacuum conditions, such as atmospheric pressure conditions.

The filling can be done by any suitable means. In some embodiments, the method includes introducing a cannula into at least a portion of the aperture to assist in the filling of the internal cavity.

In some embodiments, the aperture is at least partially sealed, for example, to prevent loss of the electro-active material from the cavity. In some embodiments, the sealant substantially fills all of the free volume remaining in the aperture, e.g., filling at least 95%, or at least 97%, or at least 99% of the free volume of the aperture. In some other embodiments, however, a lesser volume is filled with sealant, for example 5% to 95%, or 10% to 90%, or 20% to 80%. In some such embodiments, the unfilled portion of the aperture lies toward the outer end of the aperture and away from the end that lies closer to the cavity. Any suitable sealing material can be used for the sealant. In some embodiments, the sealant is a curable material, such as a thermally curable material or a photo-curable material (e.g., a UV-curable material). The sealant can have any suitable index of refraction. In some embodiments, the sealant has an index of refraction that is no more than 0.7, or no more than 0.6, or no more than 0.5, or no more than 0.4, or no more than 0.3 units different from the index of refraction of the material through which the aperture is formed. In some embodiments, the sealing material is transparent, meaning that it transmits at least 75%, or at least 80%, or at least 85%, or at least 90%, or at least 95%, or at least 97%, or at least 99% of visible light.

In embodiments where the structure includes multiple apertures, the sealant at least partially fills each of the multiple apertures, according to the embodiments described above.

In some embodiments, the electro-active optical system can include various electrical structures, such as electrical contacts and/or electrical wires, disposed on one or both of the optical substrates. In some embodiments, these electrical structures are transparent electrical structures, meaning that they transmit at least 75%, or at least 80%, or at least 85%, or at least 90%, or at least 95%, or at least 97%, or at least 99% of visible light. These electrical structures can be made of any suitable transparent conductive material, such as indium tin oxide (ITO), conductive polymers, carbon nanotubes, or any mixtures thereof. Such structures can be disposed on the surfaces of the curved substrate and/or the thin film. These structures can be disposed on the surfaces by any suitable method, including but not limited to, various lithographic or printing methods.

In some embodiments, the electro-active optical structure is a lens blank. In some such embodiments, the lens blank is designed so as to be finished into the prescription for a particular wearer or into a range of prescriptions for a range of wearers. In some other embodiments, the electro-active optical structure is a lens. In some such embodiments, the lens is designed so as to be finished into the prescription for a particular wearer or into a range of prescriptions for a range of wearers.

An any of the embodiments of the invention, the electro-active optical system can include various coatings disposed on any suitable surfaces of the first or second optical substrates. Such coatings include, but are not limited to, hard coatings, scratch-resistant coatings, antireflective coatings, and the like.

In some embodiments, the electro-active optical system can also include edging on the edges of the electro-active optical system (e.g., on the edges of the first or second optical substrates, or both) to permit the resulting lens to be fitted into a set of spectacle frames. In some embodiments, the electro-active optical system is a lens of the invention that is disposed into a set of spectacle frames.

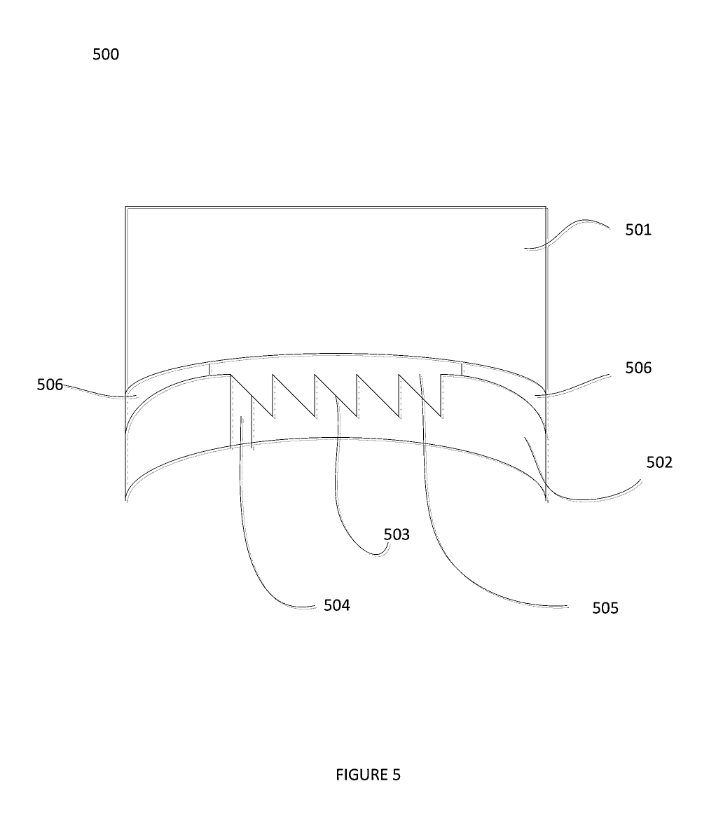

FIG. 5 depicts an electro-active optical system according to at least one embodiment of the invention 500. The figure depicts the first optical substrate 501, the second optical substrate 502, the relief structures 503, the sealed aperture 504, the electro-active cavity 505, and the adhesive layer 506.

In another aspect, the invention provides methods for laser drilling, comprising: (a) providing a transparent structure having an internal cavity, the internal cavity having a first surface and an opposing second surface; (b) using a laser, drilling an aperture from an outer surface of the transparent structure to the first surface of the internal cavity; (c) detecting ablation of the second surface of the internal cavity; and (d) upon detecting ablation of the second surface of the internal cavity, reducing the power of the laser.

In this aspect of the invention, the structure is made of a transparent material, meaning that the material transmit at least 75%, or at least 80%, or at least 85%, or at least 90%, or at least 95%, or at least 97%, or at least 99% of visible light. Any suitable transparent material can be used. Suitable transparent materials include, but are not limited to, glass, quartz, or a polymeric material, such as polycarbonate. The material can have any index of refraction suitable for use in optical applications.

The invention is not limited to the use of any particular transparent structure. In some embodiments, the transparent structure is an optical structure, such as a lens or lens blank, or a structure suitable to be finished into such structures. In some other embodiments, the transparent optical structure is an electro-active optical system, such as a, electro-active lens or an electro-active lens blank, or a structure suitable to be finished into such structures.

The cavity can be any suitable cavity. In some embodiments, the cavity is a cavity according to any of the embodiments described above. In some embodiments, the cavity is a sealed cavity.

In some embodiments, the first surface or the second surface of the cavity, or both, comprise one or more relief structures. In some such embodiments, the one or more relief structures are diffractive structures, and the cavity is a diffractive cavity. In some other such embodiments, the one or more relief structures are refractive structures, and the cavity is a refractive cavity. In some embodiments, the first surface or the second surface, or both, comprise a plurality of relief structures, for example from 2 to 500, or from 5 to 200, or from 10 to 100 relief structures. The relief structures can be formed in any suitable way, e.g., by any suitable combination of recesses and extensions from the plane of the surface. In some embodiments, the relief structures are diffractive structures. In some embodiments, the relief structures are refractive structures. In some other embodiments, the relief structures are Fresnel structures. The relief structures can be of any suitable size and shape. In some embodiments, the relief structures have a height ranging from 1 nm to 3 mm, or from 1 nm to 2 mm, or from 1 nm to 1 mm, or from 1 nm to 500 μm, or from 10 nm to 500 μm, or from 100 nm to 500 μm, or from 1 μm to 500 μm, or from 1 μm to 20 μm, or from 1 μm to 10 μm, or from 1 μm to 50 μm. In embodiments where the surface comprises a plurality of relief structures, the relief structures can be separated by any suitable distance. In some embodiments, one or more pairs of adjacent relief structures are separated by a distance ranging from 1 nm to 3 mm, or from 1 nm to 2 mm, or from 1 nm to 1 mm, or from 1 nm to 500 μm, or from 10 nm to 500 μm, or from 100 nm to 500 μm, or from 1 μm to 500 μm, or from 1 μm to 50 μm, or from 1 μm to 20 μm, or from 1 μm to 10 μm.

The first or second surfaces of the cavity, or both, can also include a recessed channel, for example, that runs through or adjacent to one or more of the one or more relief structures. Such a channel can, in some embodiments, permit the electro-active material to flow more readily across the channel upon filling of the cavity with an electro-active material.

The cavity can have any suitable dimensions. In some embodiments, where relief structures are present on at least one of the surfaces of the cavity, the height of the cavity is greater than the height of the relief structures, for example, at least two times, or at least three times, or at least four times, or at least 5 times the height of the relief structures.

The method includes using a laser to drill an aperture from an outer surface of the transparent structure to one of the surfaces of the internal cavity. Any suitable laser can be used. In some embodiments, an excimer laser is used. In some embodiments, the aperture runs to a cavity surface having relief structures. In some other embodiments, the aperture runs to a cavity not having relief structures. The aperture can have any suitable diameter. In some embodiments, the diameter ranges from 1 nm to 500 μm, or from 10 nm to 400 μm, or from 100 nm to 250 μm, or from 1 to 200 μm. The diameter need not be uniform throughout its distance. In some embodiments, for example, the diameter can taper, for example by becoming narrower in the region closer to the cavity. In some such embodiments, the taper is up to 25%, or up to 20%, or up to 15%, or up to 10%, or up to 5%. Other variations in the diameter of the aperture are within the scope of the invention.

The laser drilling operation can be carried out by any suitable means. In some embodiments, the drilling is begun directly on the outer surface to which the aperture is to run. In some other embodiments, the method includes disposing a surface saving layer on the portion of the outer surface through which the drilling will begin. This surface saving layer can, in many instances, prevent or limit the degree of damage suffered by the region on the outer surface around where the drilling is begun. In some embodiments, the surface saving layer is a surface saving tape.

The method also includes detecting ablation of a cavity surface different from the surface to which the aperture runs, e.g., an opposing surface. Any suitable means of detecting ablation on the second surface can be used. In some embodiments, a light beam (e.g., a low-power laser beam) is aligned pass through the transparent material and illuminate the region of the opposing surface where ablation will occur, once the drilling of the aperture is complete. When this light beam is incident on the opposing surface in said region, the change in the index of refraction between the transparent material and the cavity will cause an amount of the light beam to be reflected, thereby forming a reflective beam. In some embodiments, the reflective light beam is detected and some suitable characteristic of the light beam is measured (e.g., its intensity). Any suitable detection means can be used. Such detectors are well known to those of skill in the art. In such embodiments, the detector then detects some change in the measured characteristic of the reflective light beam, where the change indicates that the opposing surface is starting to be ablated by the laser drilling operation. In some embodiments, the detected change is a reduction in the intensity of the light reaching the detector, for example, because the ablation of the opposing surface is disrupting the existing features of the surface and is causing the incident light to scatter in multiple directions (instead of being reflected in a defined reflective beam).

Upon detection of the ablation of the opposing surface of the cavity, the power of the drilling laser is reduced, including reducing it to zero. This can be done by any suitable means. In embodiments such as that described immediately above, the detector provides a signal indicating that the power of the drilling laser is to be reduced. This can be done electronically or mechanically. In some embodiments, the detector provides some kind of alert (e.g., a visual alert or an auditory alert), which can be sensed by a user, who proceeds to reduce the power of the drilling laser. In some other embodiments, the detector sends a signal to a controller, which in turn effects reduction of the power of the drilling laser. Any suitable controller can be used for this purpose. Such controllers are well known to those of skill in the art.

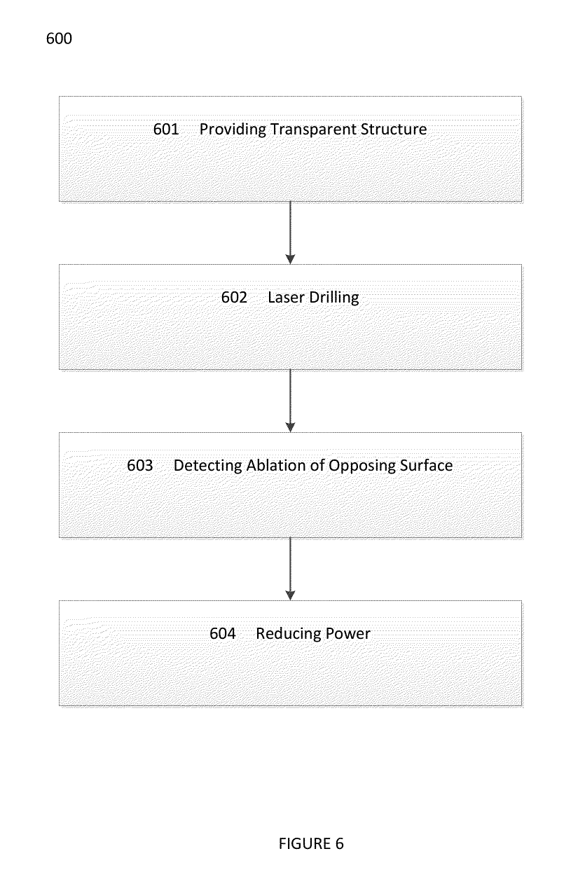

FIG. 6 depicts a flow diagram illustrating a method of laser drilling according to at least one embodiment of the invention 600. The figure shows: providing a transparent structure having an internal cavity, the internal cavity having a first surface and an opposing second surface 601; using a laser, drilling an aperture from an outer surface of the transparent structure to the first surface of the internal cavity 602; detecting ablation of the second surface of the internal cavity 603; and, upon detecting ablation of the second surface of the internal cavity, reducing the power of the laser 604.

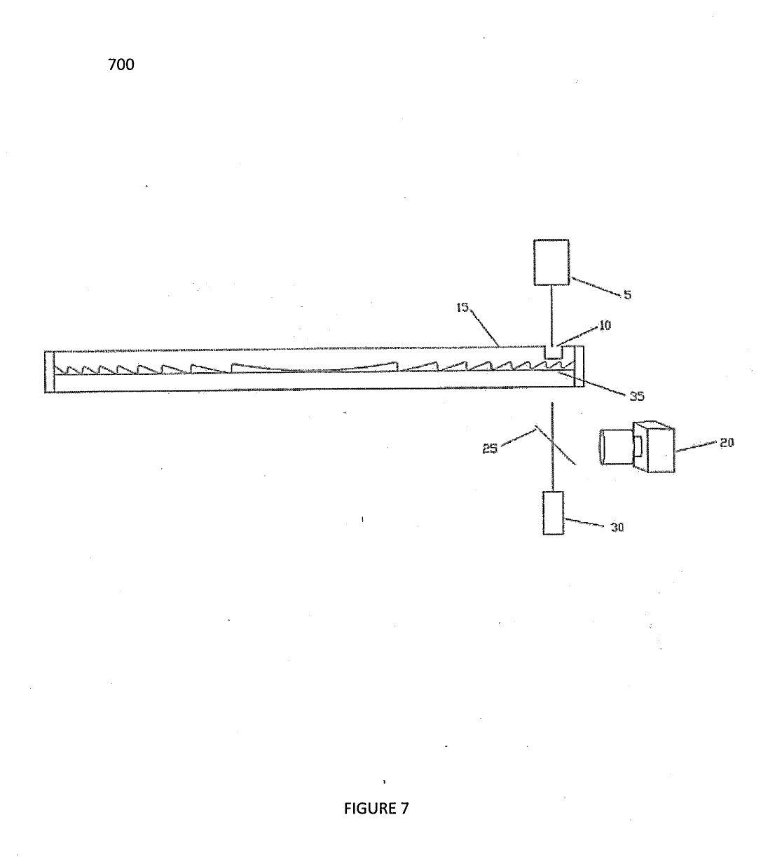

FIG. 7 depicts a drilling step according to at least one embodiment of the invention, where the laser drilling has not yet reached its end 700. The figure shows the transparent structure 15 having a cavity therein and an aperture 10 being formed by a laser 5. FIG. 7 also depicts the region of the opposing surface where ablation will occur 35, the source 30 that generates the light beam for detection of the ablation, the reflected light beam is split by a beam splitter 25, so that an amount of the reflected light contacts the detector 20.

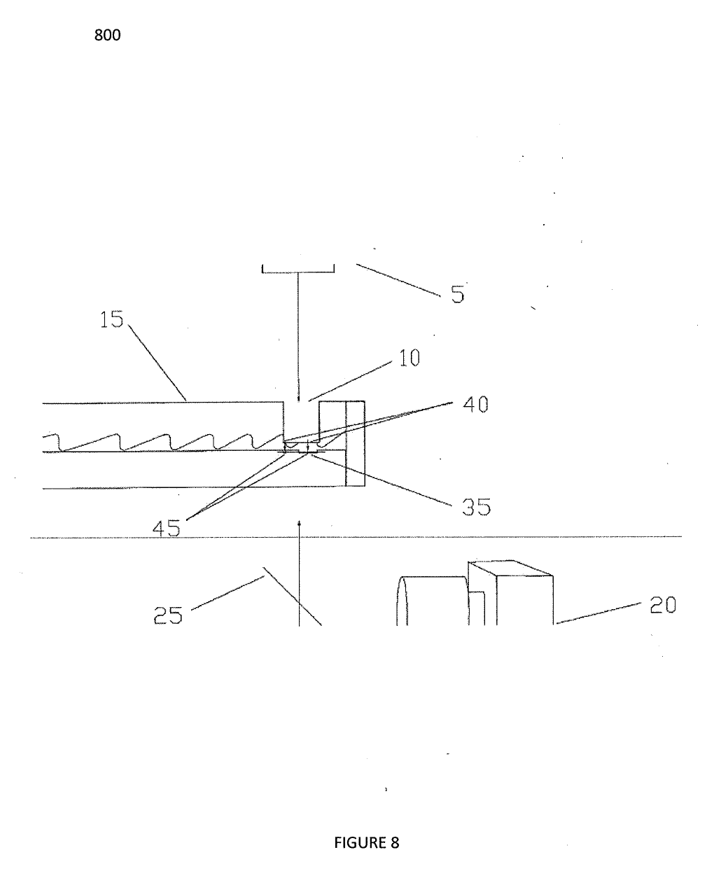

FIG. 8 depicts a drilling step according to at least one embodiment of the invention, where the laser drilling has reached its end 800. The figure shows the transparent structure 15 having a cavity therein and an aperture 10 being formed by a laser 5. FIG. 8 also depicts the region of the opposing surface where ablation will occur 35, the source 30 that generates the light beam for detection of the ablation, the reflected light beam is split by a beam splitter 25, so that an amount of the reflected light contacts the detector 20. FIG. 8 also depicts the span of the opening created in the cavity 40, and the site of the ablation of the opposing surface 45.

1. A method of fabricating an electro-active optical structure, comprising:
(a) providing a first optical substrate having a first surface, wherein the first surface is a curved surface;
(b) providing a second optical substrate having a first surface and an opposing second surface, wherein the first surface is a curved surface and the second surface is a curved surface comprising one or more relief structures;
(c) securing the second optical substrate to the first optical substrate such that the first surface of the first substrate faces the second surface of the second substrate, thereby forming a cavity between the one or more relief structures and the first surface of the first substrate;
(d) forming an aperture that runs between the cavity and an outer surface of either the first substrate or the second substrate;
(e) via the aperture, introducing an electro-active material into the cavity; and
(f) sealing the aperture to prevent loss of electro-active material from the cavity.

2. The method of claim 1, wherein the electro-active optical structure is a lens.

3. The method of claim 1, wherein the electro-active optical structure is a lens blank.

4. The method of claim 1, wherein the first optical substrate has a thickness that ranges from 50 mm to 3 cm.

5. (canceled)

6. The method of claim 5, wherein the first optical substrate has a second surface, wherein the second surface lies opposite the first surface and has a curved concave shape.

7. The method of claim 1, wherein the second optical substrate has a thickness that ranges from 500 μm to 2 mm.

8. The method of claim 1, wherein the radius of curvature of the first surface of the first optical substrate is within 15% of the radius of curvature of the second surface of the second optical substrate.

9. The method of claim 1, wherein the radius of curvature of the first surface of the second optical substrate is within 15% of the radius of curvature of the second surface of the second optical substrate.

10. The method of claim 1, wherein the one or more relief structures are diffractive structures.

11. The method of claim 1, wherein the one or more relief structures are refractive structures.

12. The method of claim 1, wherein the adhering comprises applying an adhesive to one or both of the first surface of the first substrate or the second surface of the second substrate.

13. The method of claim 1, wherein the aperture has a diameter that ranges from 100 to 500 μm.

14. The method of claim 1, wherein the forming the aperture comprises using a drill.

15. The method of claim 1, wherein the forming the aperture comprises using chemical etching.

16. The method of claim 1, wherein the forming the aperture comprises using a laser.

17. The method of claim 1, wherein the one or more relief structures have a height that ranges from 1 nm to 500 μm.

18. The method of claim 1, wherein the first surface of the second substrate comprises a plurality of relief structures, and wherein one or more adjacent pairs of relief structures are separated by a distance ranging from 1 nm to 500 μm.

19. The method of claim 1, wherein the electro-active material comprises liquid crystals.

20. The method of claim 1, wherein the sealing comprises introducing a curable material into the aperture.

21. The method of claim 20, wherein the curable material, upon curing, has an index of refraction that is no more than 0.5 units different from the index of refraction of the material through which the aperture was formed.

22-27. (canceled)

28. The method of claim 2, wherein the securing step (c) comprises forming a lens blank, and wherein the method further comprises processing the semi-finished lens blank into a lens.

29. The method of claim 28, wherein the processing step is carried out after the securing step (c) and before the forming step (d).

30. The method of claim 28, wherein the processing step is carried out after the sealing step (f).

31. The method of claim 28, wherein the processing step is carried out after the securing step (c) and before the introducing step (e).

32-33. (canceled)

34. An electro-active optical structure comprising:
(a) a first optical substrate having a first surface, wherein the first surface is a curved surface; and
(b) a second optical substrate having a first surface and an opposing second surface, wherein the first surface is a curved surface and the second surface is a curved surface comprising one or more relief structures;
wherein the second optical substrate is disposed on the first optical substrate such that the first surface of the first substrate faces the second surface of the second substrate, thereby forming a cavity between the one or more relief structures and the first surface of the first substrate, the cavity being substantially filled with an electro-active material; and
wherein a sealed aperture runs between the cavity and the first surface of the second substrate.

35-58. (canceled)

59. A method for laser drilling, comprising:
(a) providing a transparent structure having an internal cavity, the internal cavity having a first surface and an opposing second surface;
(b) using a laser, drilling an aperture from an outer surface of the transparent structure to the first surface of the internal cavity;
(c) detecting ablation of the second surface of the internal cavity;
(d) upon detecting ablation of the second surface of the internal cavity, reducing the power of the laser.

60-69. (canceled)
